(19) United States
(12) Patent Application Publication
(10) Pub. No.: US 2022/0343788 A1
(43) Pub. Date: Oct. 27, 2022

(54) SYSTEMS AND METHODS FOR PROVIDING IMMERSIVE AVIONICS TRAINING

(71) Applicant: Honeywell International Inc., Charlotte, NC (US)

(72) Inventors: Mahesh SIVARATRI, Bangalore (IN); Raghu SHAMASUNDAR, Bangalore (IN); Srihari JAYATHIRTHA, Bangalore (IN)

(21) Appl. No.: 17/658,261

(22) Filed: Apr. 7, 2022

(30) Foreign Application Priority Data
Apr. 27, 2021 (IN) 202111019287

(51) Int. Cl. G09B 9/30; G09B 9/16; G06F 3/01

(52) U.S. Cl. CPC G09B 9/301; G09B 9/307; G09B 9/165; G06F 3/013

(57) ABSTRACT

Systems and methods for providing immersive avionics training include controlling a virtual or augmented reality device to present, to a user, a virtual or augmented reality simulation of a user interface of an avionics system including a simulation of a display of the avionics system. The method further includes detecting a user action based on a point of gaze and touch inputs of the user indicative of a user command to use a functionality of the avionics system. The user action is a physical interaction with a control panel apparatus representing an input device of the user interface of the avionics system. The method also includes simulating the use of the functionality in accordance with the user command to generate output data and controlling the virtual or augmented reality device to simulate display of the output data in the simulation of the display of the avionics system.

### CROSS-REFERENCE TO RELATED APPLICATIONS

This application claims the benefit of priority under 35 U.S.C. § 119 from Indian Patent Application No. 202111019287, filed on Apr. 27, 2021, the contents of which are incorporated by reference in their entirety.

### TECHNICAL FIELD

Various embodiments of the present disclosure generally relate to virtual reality systems and, more particularly, to systems and methods for providing immersive avionics training.

### BACKGROUND

In aviation, pilot training encompasses ground school, flight training devices (FTD), and a full flight simulator (FFS). Effective training requires building a training simulator lab and building an avionics model to re-create the cockpit environment during training. Accordingly, it is expensive to effectively train new pilots. Further, the avionics models may provide the touch and feel of the corresponding components of the aircraft during the simulator training. However, such systems may be expensive and include poor graphics, and thus it may be difficult to achieve a realistic sense of immersion during simulator training.

One solution includes the use of virtual reality (VR) or augmented reality (AR) systems to create a sense of immersion for trainees and to increase training efficiency and effectiveness. VR and AR systems may provide three-dimensional (3D) insights and immersion into the structures and functions of the avionics systems for which the user is training. Further, using VR and/or AR may reduce the cost of training aspects. However, VR and/or AR alone may not provide the feel of the real world avionics systems and does not provide users with the ability to physically interact with the avionics systems. Further, current VR and/or AR systems may require numerous sensors and components to provide such physical interaction and may inaccurately detect user interaction.

The present disclosure is directed to addressing one or more of these above-referenced challenges. The background description provided herein is for the purpose of generally presenting the context of the disclosure. Unless otherwise indicated herein, the materials described in this section are not prior art to the claims in this application and are not admitted to be prior art, or suggestions of the prior art, by inclusion in this section.

### SUMMARY OF THE DISCLOSURE

According to certain aspects of the disclosure, systems and methods are disclosed for providing immersive avionics training.

In one embodiment, a computer-implemented method for providing immersive avionics training is disclosed. The method includes: controlling a virtual or augmented reality device to present, to a user, a virtual or augmented reality simulation of a user interface of an avionics system, the simulation including a simulation of a display of the avionics system; detecting a user action of the user based on a point of gaze of the user and touch inputs of the user indicative of a user command to use a functionality of the avionics system, the user action being a physical interaction with a control panel apparatus representing an input device of the user interface of the avionics system; simulating the use of the functionality in accordance with the user command, wherein the simulating the use of the functionality generates output data; and controlling the virtual or augmented reality device to simulate display of the output data in the simulation of the display of the avionics system.

In another embodiment, a system for providing immersive avionics training is disclosed. The system includes: a memory having processor-readable instructions therein; and at least one processor configured to access the memory and execute the processor-readable instructions, which when executed by the processor configures the processor to perform a plurality of functions, including functions for: controlling a virtual or augmented reality device to present, to a user, a virtual or augmented reality simulation of a user interface of an avionics system, the simulation including a simulation of a display of the avionics system; detecting a user action of the user based on a point of gaze of the user and touch inputs of the user indicative of a user command to use a functionality of the avionics system, the user action being a physical interaction with a control panel apparatus representing an input device of the user interface of the avionics system; simulating the use of the functionality in accordance with the user command, wherein the simulating the use of the functionality generates output data; and controlling the virtual or augmented reality device to simulate display of the output data in the simulation of the display of the avionics system.

In yet another embodiment, non-transitory computer-readable medium containing instructions for providing immersive avionics training is disclosed. The instructions include instructions for: controlling a virtual or augmented reality device to present, to a user, a virtual or augmented reality simulation of a user interface of an avionics system, the simulation including a simulation of a display of the avionics system; detecting a user action of the user based on a point of gaze of the user and touch inputs of the user indicative of a user command to use a functionality of the avionics system, the user action being a physical interaction with a control panel apparatus representing an input device of the user interface of the avionics system; simulating the use of the functionality in accordance with the user command, wherein the simulating the use of the functionality generates output data; and controlling the virtual or augmented reality device to simulate display of the output data in the simulation of the display of the avionics system.

Additional objects and advantages of the disclosed embodiments will be set forth in part in the description that follows, and in part will be apparent from the description, or may be learned by practice of the disclosed embodiments. The objects and advantages of the disclosed embodiments will be realized and attained by means of the elements and combinations particularly pointed out in the appended claims.

It is to be understood that both the foregoing general description and the following detailed description are exemplary and explanatory only and are not restrictive of the disclosed embodiments, as claimed.

### BRIEF DESCRIPTION OF THE DRAWINGS

The accompanying drawings, which are incorporated in and constitute a part of this specification, illustrate various exemplary embodiments and together with the description, serve to explain the principles of the disclosed embodiments.

FIG. 1 depicts an exemplary system for providing immersive avionics training, according to one or more embodiments.

FIG. 2 depicts block diagram illustrating an exemplary system architecture for providing immersive avionics training, according to one or more embodiments.

FIG. 3 depicts a flowchart of an exemplary method for providing immersive avionics training, according to one or more embodiments

FIG. 4 depicts an example system that may execute techniques presented herein.

### DETAILED DESCRIPTION OF EMBODIMENTS

In general, systems and methods of the present disclosure provide for an improved immersive avionics training system. The system of the present disclosure may include virtual reality (VR) and/or augmented reality (AR) systems in combination with a three-dimensional (3D) printed model of an avionics device. For example, the model may include a model of a multi control display unit (MCDU) and a flight control unit (FCU) of an aircraft. The 3D printed model may include manipulable controls, such as buttons, knobs, switches, joysticks, etc. that correspond with the actual manipulable controls of the aircraft for which the users are training. Thus, the model with the VR and/or AR systems provides users with an experience of real time sensitive touch so that the users can physically interact with the model during simulation training. Further, graphic-centric information (e.g., heads-up displays, etc.) may be virtually projected onto the model via the VR and/or AR systems. The system may include external sensors (e.g., GPS, etc.) to enable external projected data to be integrated with the 3D printed model to enable real time experience for the user.

The system of the present disclosure may further include gaze sensors and a wearable device (e.g., a smart watch) for detecting user interaction with the 3D printed model. Thus, the system as disclosed herein may provide for an accurate detection of user interaction with the model. Further, the system may eliminate the need for additional external sensors to detect user interaction, such as external infrared sensors, ultrasonic sensors, inertial sensors, or other types of sensors for detecting position and movement of the user. Therefore, the systems and methods of the present disclosure reduce the complexity of the system, provide for increased accuracy of user detection interaction, and provide for increased processing speed due to reduced inputs.

In the following description, embodiments will be described with reference to the accompanying drawings. The terminology used in this disclosure may be interpreted in its broadest reasonable manner, even though it is being used in conjunction with a detailed description of certain specific examples of the present disclosure. Indeed, certain terms may even be emphasized below; however, any terminology intended to be interpreted in any restricted manner will be overtly and specifically defined as such in this Detailed Description section. Both the foregoing general description and the following detailed description are exemplary and explanatory only and are not restrictive of the features, as claimed.

In this disclosure, the term “based on” means “based at least in part on.” The singular forms “a” and “an” include plural referents unless the context dictates otherwise. The term “exemplary” is used in the sense of “example” rather than “ideal.” The terms “information,” “data,” and “content” may be interchangeable when permitted by context. The terms “record” and “store,” in the sense of recording or storing data, may be interchangeable when permitted by context. The terms “comprises,” “comprising,” “includes,” “including,” and other variations thereof, are intended to cover a non-exclusive inclusion such that a process, method, or product that comprises a list of elements does not necessarily include only those elements, but may include other elements not expressly listed or inherent to such a process, method, article, or apparatus. The terms “one or more” includes a function being performed by one element, a function being performed by more than one element, e.g., in a distributed fashion, several functions being performed by one element, several functions being performed by several elements, or any combination of the above. It will also be understood that, although the terms first, second, etc. are, in some instances used herein to describe various elements, these elements should not be limited by these terms. These terms are only used to distinguish one element from another. For example, a first contact could be termed a second contact, and, similarly, a second contact could be termed a first contact, without departing from the scope of the various described embodiments. The first contact and the second contact are both contacts, but they are not the same contact

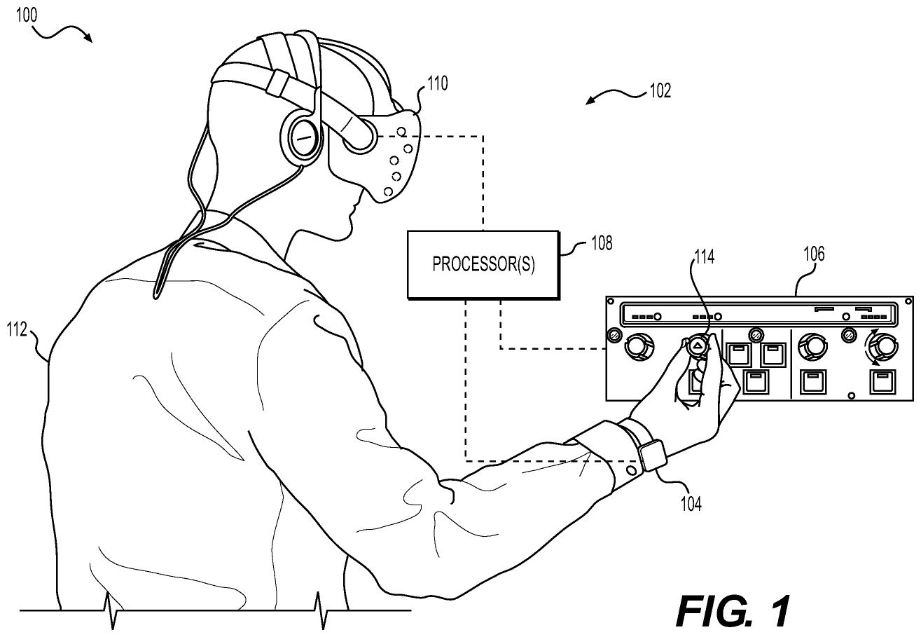

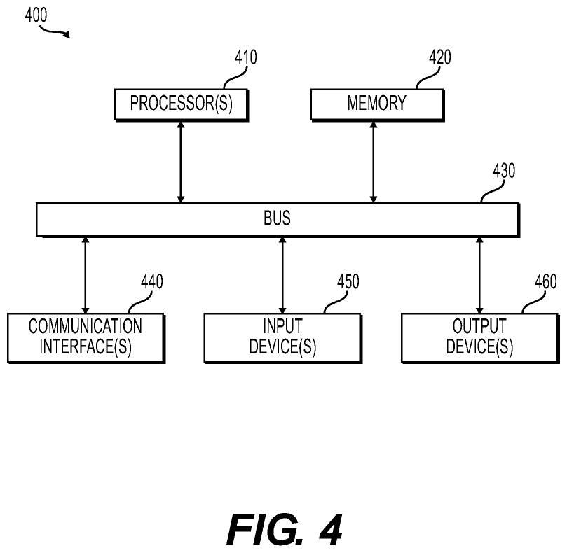

Referring now to the appended drawings, FIG. 1 illustrates an exemplary system 100 for providing immersive avionics training, according to the present disclosure. System 100 may include a virtual or augmented reality system 102 (hereinafter referred to as an “AR system”), a wearable device 104, and a control panel 106. In general, AR system 102 may be a computer system, such as the system 400 depicted in FIG. 4. In this disclosure, the term “computer system” generally encompasses any device or combination of devices, each device having at least one processor that executes instructions from a memory. Additionally, a computer system may be part of another computer system.

The AR system 102 may include one or more processors 108 and a display system 110. Display system 110 may be deployed as being part of any one of a variety of wearable devices, such as, for example, glasses, goggles, helmets, or any other wearable display device. Display system 110 may be implemented using known virtual reality displays and/or augmented reality displays. For example, display system 110 may include a see-through display surface suitable for rendering textual, graphic, and/or iconic information in a format viewable by a user 112. Display system 110 may support virtual or augmented reality visualization using two-dimensional images, three-dimensional images, and/or animations. Accordingly, the display system 110 communicates with the one or more processors 108 using a communication protocol that is either two-dimensional or three-dimensional, and may support the visualization of text, alphanumeric information, objects, visual symbology, and the like, as described herein. While the exemplary embodiment described herein describes the one or more processors 108 and the display system 110 as being part of a single device (e.g., AR system 102), it is understood that the display system 110 may be included as a separate device from AR system 102. For example, AR system 102 including the one or more processors 108 may be separate, or remote, from the display system 110. Thus, display system 110 may be in communication with the AR system 102 through wired and/or wireless means. For example, display system 110 may send data to and/or receive data from the one or more processors 108 of AR system 102. The wired and/or wireless communication means may include, for example, a local area network (LAN), a Wide Area Network (WANs), cellular, radio, Bluetooth, Wi-Fi, Near Field Communication (NFC), or any other type of wired and/or wireless communication means that provides communications between one or more components of the system 102.

Wearable device 104 may include any type of device worn by, attached to, or otherwise associated, with the user 112 for detecting touch inputs of the user 112. Wearable device 104 may include, for example, a smart watch, or the like, having one or more sensors for sensing the touch inputs, gestures, or other movements of the user 112. For example, the one or more sensors of wearable device 104 may include one or more pulse sensors, inertial sensors (e.g., gyroscopes), optical sensors, mechanical contact sensors, myoelectric sensors, and/or any other type of sensor for sensing touch inputs, gestures, or other movements of the user 112. The one or more sensors of wearable device 104 may send signals indicative of the touch inputs, gestures, or other movements of user 112 to the one or more processors 108 of AR system 102. Wearable device 104 may be in communication with AR system 102 through wired and/or wireless means, as described above. For example, wearable device 104 may send data to and/or receive data from the one or more processors 108 of AR system 102. While the exemplary embodiment depicts wearable device 104 as a single device, it is understood that wearable device 104 may include any number of devices including any number of different sensors for detecting touch inputs, gestures, or other movements of the user 112.

Control panel 106 may include a physical module or component in which the user 112 may interact with during immersive avionics training. The control panel 106 may provide the feeling of touch or tactile sensation, such as, for example, force feedback. Accordingly, the control panel 106 may include one or more manipulable controls 114 that the user 112 can interact with for simulating actual controls of an aircraft control panel. The manipulable controls 114 may include, for example, any number of buttons, switches, dials, knobs, joysticks, levers, steering wheels, touch screens, displays, gauges, microphones, jacks, or any other desired type of device that may be present on an actual aircraft or vehicle control panel. As such, the control panel 106 may be designed to replicate a control panel of an aircraft for which the user 112 is being trained. For example, the control panel 106 may include a multi-function control and display unit (MCDU) and/or a flight control unit (FCU) of a specific type of aircraft. The control panel 106 may be 3D printed such that the control panel 106 can be readily and easily designed to replicate a control panel of a specific type of aircraft. Thus, the control panel 106 may provide a physical medium to help the user 112 feel the real world interaction with the control panel. It is understood that the control panel 106 may be manufactured by any means, including other additive manufacturing techniques, machining, casting, molding, vacuum forming, injection molding, or any other type of manufacturing process.

As detailed further below, AR system 102 may present a virtual or augmented reality simulation of the control panel 106, detect interaction of a user 110 with the control panel 106, and simulate the use of the control panel 106 based on the detected interaction of the control 106 by the user 110.

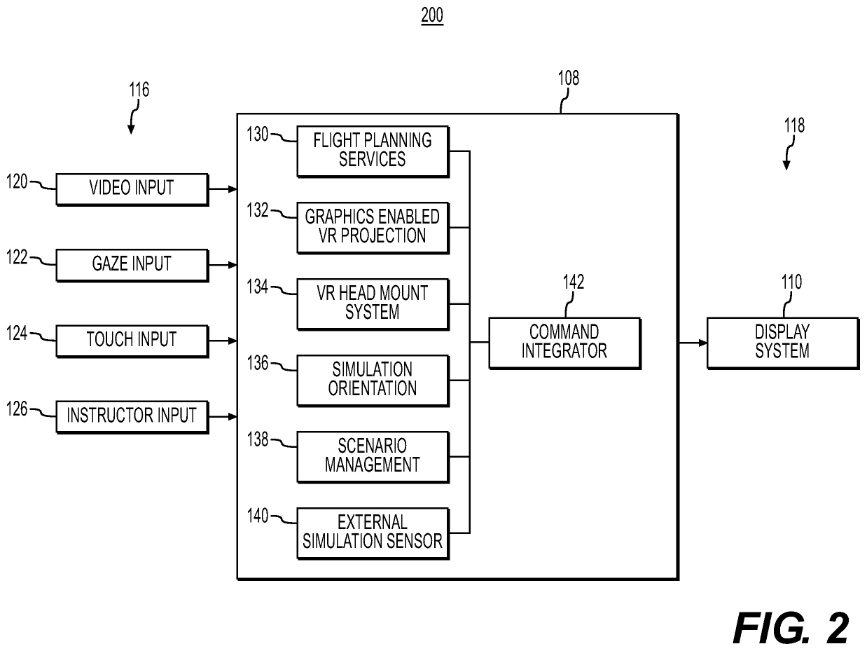

FIG. 2 is a block diagram of an exemplary AR system 102, according to one or more embodiments. The AR system 102 may include inputs 116, the one or more processors 108, and outputs 118. Inputs 116 may include video input 120, gaze input 122, touch input 124, and instructor input 126.

Video input 120 may include a camera mounted to the display 110 or associated wearable platform that the user 112 may wear. The video input 120 is understood to be oriented to capture video input inclusive of a field of view of the user 112 when the user 112 is wearing the wearable platform. Accordingly, video input 120 may include a video stream. Video input 120 may relay video information of control panel 106 and/or user interaction with control panel 106 to the one or more processors 108. It is understood that video input 120 may include any type of sensor for detecting a location of the control panel 106, manipulable controls 114, and/or the user's hands.

Gaze input 122 may include a sensor mounted to, or otherwise associated with, display 110 for detecting eye movement of the user 112. The sensor for detecting the eye movement of the user 112 may be an inward facing sensor and may include a camera, or any other type of sensor for detecting eye movement of the user 112. The one or more processors 108 may receive the eye movement from the sensor and determine or otherwise derive the gaze of the user 112. As used herein, “gaze” may include a direction of the user's vision based on the movement and/or location of the user's eyes. Thus, gaze input 122 may include a direction of gaze of user 112. It is understood that AR system 102 may include any number of sensors or other devices located in any location for detecting the eye movement and/or gaze of the user 112. Further, AR system 102 may also include other sensors for detecting movement and/or location of the user's head. As such, the one or more processors 108 may also derive or otherwise determine the gaze input 122 using a direction of the user's head based on the movement and/or location of the user's head.

Touch input 124 may include signals received by the one or more processors 108 from the wearable device 104. As such, touch input 124 may include force feedback as detected by the sensors (e.g., pulse sensors, inertial sensors, etc.) of wearable device 104. For example, when the user 112 interacts with the control panel 106 by pressing a button, turning a knob, pushing a switch, controlling a joystick, etc., the sensors of wearable device 104 may provide feedback of the user interaction. For example, the sensors of wearable device 104 may detect rotation of the user's hand, force of the user's finger when pushing or pressing, and/or any other type gesture or touch of the user 112. Accordingly, touch input 124 may provide an indication of the user's physical interaction with the control panel 104.

Instructor input 126 may include one or more input devices, such as input devices 450 (e.g., a keyboard, mouse, or touchscreen), as detailed below with respect to FIG. 4. Instructor input 126 may enable another user, such as an instructor of the training program, to invoke a scenario management module 138 during a simulated training and add real time situation for the pilot to handle, as detailed below. Accordingly instructor input 126 may enable an instructor to configure the training simulation and execute various training scenarios.

The one or more processors 108 may further include, or otherwise be in communication with, one or more modules 130-142. The one or more modules 130-142 may include a flight planning services module 130, a graphics enabled VR projection module 132, a VR head mount system module 134, a simulation orientation module 136, a scenario management module 138, an external simulation sensor module 140, and a command integrator module 142, which may each be software components stored in the computer system 400. The one or more processors 108 may be configured to utilize the one or more modules 130-142 when performing various methods described in this disclosure. In some examples, the computer system 400 may have a cloud computing platform with scalable resources for computation and/or data storage, and may run one or more applications on the cloud computing platform to perform various computer-implemented methods described in this disclosure. In some embodiments, some of the one or more modules 130-142 may be combined to form fewer modules. In some embodiments, some of the one or more modules 130-142 may be separated into separate, more numerous modules. In some embodiments, some of the one or more modules 130-142 may be removed while others may be added.

The flight planning services module 130 may include a simulation of a flight management system (FMS) for providing flight planning data to the AR system 102 during a training simulation. For example, the flight planning services module 130 may receive the flight planning data from a cloud service and provide the flight planning data to the display system 110. The flight planning services module 130 may render required data on the control panel 106 via the display system 110 based on a flight planning rule set. For example, the flight planning services module 130 may receive video input 120 and other sensor input, and may determine an orientation of the display system 110 with respect to the control panel 106. Accordingly, flight planning services module 130 may project the flight planning data on the display system 110 over the control panel 106 based on the orientation of the display system 110 (e.g., the orientation of the user's head) with respect to the control panel 106.

The graphics enabled VR projection module 132 may provide integration of simulator data from the flight planning services module 130 to enable training through running virtually on the display system 110. The graphics enabled VR projection module 132 may project the flight planning data on the control panel 106. The graphics enabled VR projection module 132 may also process, detect, or otherwise determine interaction between the simulator data (e.g., virtually running flight planning services software) and the control panel 106.

The VR head mount system module 134 may provide a projection system that enables visualization of the virtual world on the control panel 106. The VR head mount system module 134 may operate from the flight planning services module 130 in combination with the external simulation sensor module 140 to run a projection of the FMS. The VR head mount system module 134 may be capable of processing graphics data projections.

The simulation orientation module 136 may provide orientation against the display system 110 and may provide constant updates of the virtual world data on to the control panel 106 with defined form factor. The simulation orientation module 136 may provide continuous orientation information to the display system 110 to project the flight planning data on to the control panel 106.

The scenario management module 138 may store various scenarios for a specific condition. For example, the scenarios may include execution of engine out condition, depressurization condition, or any other flight training scenario. Based on the scenarios and conditions, the flight planning services module 130 may be invoked to render the simulated display on display system 110. The instructor may invoke the scenario management module 130 during training and can add real time situation for the user 112 to handle.

The external simulation sensor module 140 may be integrated, or otherwise in communication, with the flight planning services module 130 to provide real time FMS capability. For example, the external simulation sensor module 140 may communicate with external sources, such as global position system (GPS) or other sources to provide external input to the simulator projected training.

The command integrator module 142 may provide an interface between the control panel 106 and the projected graphics data (e.g., the display of the flight planning services data). The command integrator module 142 may convert the touch input 124 into a respective actionable command (e.g., pushing button, pressing switch, turning knob, etc.). The command integrator module 142 may then send the actionable command data to the flight planning system to process the command and render the computed information on the projected display on display system 110.

Display system 110 output may include the one or more processors 108 controlling the display system 110 to present, to the user 112, a virtual or augmented reality simulation of the user interface of the control panel 106 (e.g., the avionics system). Thus, the one or more processors 108 may cause display of the avionic systems on top of the physical control panel 106. The one or more processors 108 may receive the commands, as detailed above, and control the display system 110 to simulate display of output data in the simulation of the display of the avionics system.

In the exemplary embodiment, the control panel 106 may include an avionics module, such as the MCDU and FCU, as detailed above. The AR system 102 may project FMS data over, or otherwise in conjunction with, the MCDU via the display system 110. The user 112 may select a line select key of the control panel 106 to actually press a button to enter data on the flight planning system. Similarly, when the user 112 would like to change some of the parameters of the FMS, such as altitude, speed, heading, etc., the user 112 may use the physical manipulable object (e.g., button, switch, knob, etc.) on the control panel 106. Based on the interaction of the control panel 106 by the user 112, the corresponding command will be integrated into the flight planning service of the VR projection.

While the exemplary embodiment described herein includes a single user 112, it is understood that user 112 may include one or more users 112 each having their own display system 110 and wearable device 104. Accordingly, the one or more users 112 may include pilots, co-pilots, and/or any other crew that may interact with an avionics system of an aircraft.

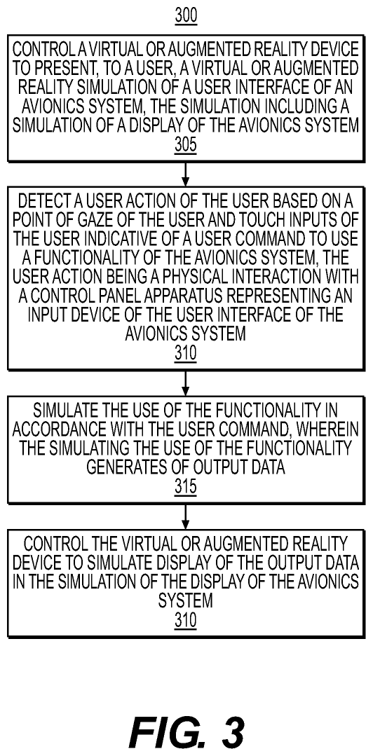

FIG. 3 is a flowchart of a method 300 for providing immersive avionics training, according to one or more embodiments. In an initial step 305, the one or more processors 108 may control a virtual or augmented reality device (e.g., display system 110) to present, to a user, a virtual or augmented reality simulation of a user interface of an avionics system, the simulation including a simulation of a display of the avionics system. As detailed above, the avionics system may include a flight management system (FMS) and the input device may include a control panel 106 of a flight control unit (FCU) and/or a multi-function control and display unit (MCDU).

In step 310, the one or more processors 108 may detect a user action of the user 112 based on a point of gaze of the user 112 and touch inputs 124 of the user 112 indicative of a user command to use a functionality of the avionics system. The user action may include a physical interaction with a control panel 106 apparatus representing an input device of the user interface of the avionics system. As detailed above, to detect the point of gaze of the user 112, the one or more processors may detect an eye movement of the user 112 and determine the point of gaze of the user 112 based on the eye movement. For example, the one or more processors 108 may receive gaze input 122 to detect the eye movement of the user 112 and determine the point of gaze, as detailed above. The functionality may include a flight planning functionality of the FMS. Further, as detailed above, the control panel 106 may include a user-manipulable object 114 (e.g., a button, switch, knob, etc.) that represents a respective object of the input device. Accordingly, the physical interaction includes a manipulation of the user-manipulable object 114 by the user 112.

In step 315, the one or more processors 108 may simulate the use of the functionality in accordance with the user command. The simulating the use of the functionality generates output data. For example, the output data may include flight plan information generated by simulation of the flight planning functionality.

In step 320, the one or more processors 108 may control the virtual or augmented reality device (e.g., AR system 102) to simulate display (e.g., on display system 110) of the output data in the simulation of the display of the avionics system.

In general, any process discussed in this disclosure that is understood to be computer-implementable, such as the process illustrated in FIG. 3, may be performed by one or more processors of a computer system, such as system 400, as described below. A process or process step performed by one or more processors may also be referred to as an operation. The one or more processors may be configured to perform such processes by having access to instructions (e.g., software or computer-readable code) that, when executed by the one or more processors, cause the one or more processors to perform the processes. The instructions may be stored in a memory of the computer system. A processor may be a central processing unit (CPU), a graphics processing unit (GPU), or any suitable type of processing unit.

A computer system, such as AR system 102, may include one or more computing devices. If the one or more processors 108 of the AR system 102 are implemented as a plurality of processors, the plurality of processors may be included in a single computing device or distributed among a plurality of computing devices. If AR system 102 comprises a plurality of computing devices, the memory of the AR system 102 may include the respective memory of each computing device of the plurality of computing devices.

FIG. 4 illustrates an example of a computing device 400 of a computer system, such as AR system 102. The computing device 400 may include processor(s) 410 (e.g., CPU, GPU, or other such processing unit(s)), a memory 420, and communication interface(s) 440 (e.g., a network interface) to communicate with other devices. Memory 420 may include volatile memory, such as RAM, and/or non-volatile memory, such as ROM and storage media. Examples of storage media include solid-state storage media (e.g., solid state drives and/or removable flash memory), optical storage media (e.g., optical discs), and/or magnetic storage media (e.g., hard disk drives). The aforementioned instructions (e.g., software or computer-readable code) may be stored in any volatile and/or non-volatile memory component of memory 420. The computing device 400 may, in some embodiments, further include input device(s) 450 (e.g., a keyboard, mouse, or touchscreen) and output device(s) 460 (e.g., a display, printer). The aforementioned elements of the computing device 400 may be connected to one another through a bus 430, which represents one or more busses. In some embodiments, the processor(s) 410 of the computing device 400 includes both a CPU and a GPU.

Instructions executable by one or more processors may be stored on a non-transitory computer-readable medium. Therefore, whenever a computer-implemented method is described in this disclosure, this disclosure shall also be understood as describing a non-transitory computer-readable medium storing instructions that, when executed by one or more processors, cause the one or more processors to perform the computer-implemented method. Examples of non-transitory computer-readable medium include RAM, ROM, solid-state storage media (e.g., solid state drives), optical storage media (e.g., optical discs), and magnetic storage media (e.g., hard disk drives). A non-transitory computer-readable medium may be part of the memory of a computer system or separate from any computer system.

It should be appreciated that in the above description of exemplary embodiments, various features are sometimes grouped together in a single embodiment, figure, or description thereof for the purpose of streamlining the disclosure and aiding in the understanding of one or more of the various inventive aspects. This method of disclosure, however, is not to be interpreted as reflecting an intention that the claims require more features than are expressly recited in each claim. Rather, as the following claims reflect, inventive aspects lie in less than all features of a single foregoing disclosed embodiment. Thus, the claims following the Detailed Description are hereby expressly incorporated into this Detailed Description, with each claim standing on its own as a separate embodiment of this disclosure.

Furthermore, while some embodiments described herein include some but not other features included in other embodiments, combinations of features of different embodiments are meant to be within the scope of the disclosure, and form different embodiments, as would be understood by those skilled in the art. For example, in the following claims, any of the claimed embodiments can be used in any combination.

Thus, while certain embodiments have been described, those skilled in the art will recognize that other and further modifications may be made thereto without departing from the spirit of the disclosure, and it is intended to claim all such changes and modifications as falling within the scope of the disclosure. For example, functionality may be added or deleted from the block diagrams and operations may be interchanged among functional blocks. Steps may be added or deleted to methods described within the scope of the present disclosure.

The above disclosed subject matter is to be considered illustrative, and not restrictive, and the appended claims are intended to cover all such modifications, enhancements, and other implementations, which fall within the true spirit and scope of the present disclosure. Thus, to the maximum extent allowed by law, the scope of the present disclosure is to be determined by the broadest permissible interpretation of the following claims and their equivalents, and shall not be restricted or limited by the foregoing detailed description. While various implementations of the disclosure have been described, it will be apparent to those of ordinary skill in the art that many more implementations and implementations are possible within the scope of the disclosure. Accordingly, the disclosure is not to be restricted.

Other embodiments of the disclosure will be apparent to those skilled in the art from consideration of the specification and practice of the invention disclosed herein. It is intended that the specification and examples be considered as exemplary only, with a true scope and spirit of the invention being indicated by the following claims.

What is claimed is:

1. A computer-implemented method for providing immersive avionics training, comprising:
controlling a virtual or augmented reality device to present, to a user, a virtual or augmented reality simulation of a user interface of an avionics system, the simulation including a simulation of a display of the avionics system;
detecting a user action of the user based on a point of gaze of the user and touch inputs of the user indicative of a user command to use a functionality of the avionics system, the user action being a physical interaction with a control panel apparatus representing an input device of the user interface of the avionics system;
simulating the use of the functionality in accordance with the user command, wherein the simulating the use of the functionality generates output data; and
controlling the virtual or augmented reality device to simulate display of the output data in the simulation of the display of the avionics system.

2. The computer-implemented method of claim 1, further including:
detecting an eye movement of the user;
determining the point of gaze of the user based on the eye movement.

3. The computer-implemented method of claim 1, further including:
receiving the touch inputs of the user from a device including pulse sensors and inertial sensors.

4. The computer-implemented method of claim 1, wherein
the avionics system is a flight management system (FMS),
the input device is a control panel of a flight control unit (FCU) or a multi-function control and display unit (MCDU),
the functionality is a flight planning functionality of the FMS, and
the output data includes flight plan information generated by simulation of the flight planning functionality.

5. The computer-implemented method of claim 1, wherein
the control panel apparatus includes a user-manipulable object, the user-manipulable object being a button, switch, or knob representing a button, switch, or knob of the input device, and
the physical interaction is a manipulation of the user-manipulable object by the user.

6. The computer-implemented method of claim 1, wherein the virtual or augmented reality simulation of the user interface of the avionics system includes an augmented reality display of the user interface of the avionics system overlaid on the control panel apparatus.

7. The computer-implemented method of claim 1, wherein the control panel apparatus is a 3D printed apparatus.

8. A system for providing immersive avionics training, comprising:
a memory having processor-readable instructions therein; and
at least one processor configured to access the memory and execute the processor-readable instructions, which when executed by the processor configures the processor to perform a plurality of functions, including functions for:
controlling a virtual or augmented reality device to present, to a user, a virtual or augmented reality simulation of a user interface of an avionics system, the simulation including a simulation of a display of the avionics system;
detecting a user action of the user based on a point of gaze of the user and touch inputs of the user indicative of a user command to use a functionality of the avionics system, the user action being a physical interaction with a control panel apparatus representing an input device of the user interface of the avionics system;
simulating the use of the functionality in accordance with the user command, wherein the simulating the use of the functionality generates output data; and
controlling the virtual or augmented reality device to simulate display of the output data in the simulation of the display of the avionics system.

9. The system of claim 8, further including functions for:
detecting an eye movement of the user;
determining the point of gaze of the user based on the eye movement.

10. The system of claim 8, further including functions for:
receiving the touch inputs of the user from a device including pulse sensors and inertial sensors.

11. The system of claim 8, wherein
the avionics system is a flight management system (FMS),
the input device is a control panel of a flight control unit (FCU) or a multi-function control and display unit (MCDU),
the functionality is a flight planning functionality of the FMS, and
the output data includes flight plan information generated by simulation of the flight planning functionality.

12. The system of claim 8, wherein
the control panel apparatus includes a user-manipulable object, the user-manipulable object being a button, switch, or knob representing a button, switch, or knob of the input device, and
the physical interaction is a manipulation of the user-manipulable object by the user.

13. The system of claim 8, wherein the virtual or augmented reality simulation of the user interface of the avionics system includes an augmented reality display of the user interface of the avionics system overlaid on the control panel apparatus.

14. The system of claim 8, wherein the control panel apparatus is a 3D printed apparatus.

15. A non-transitory computer-readable medium containing instructions for providing immersive avionics training, comprising:
controlling a virtual or augmented reality device to present, to a user, a virtual or augmented reality simulation of a user interface of an avionics system, the simulation including a simulation of a display of the avionics system;
detecting a user action of the user based on a point of gaze of the user and touch inputs of the user indicative of a user command to use a functionality of the avionics system, the user action being a physical interaction with a control panel apparatus representing an input device of the user interface of the avionics system;
simulating the use of the functionality in accordance with the user command, wherein the simulating the use of the functionality generates output data; and
controlling the virtual or augmented reality device to simulate display of the output data in the simulation of the display of the avionics system.

16. The non-transitory computer-readable medium of claim 15, further including:
detecting an eye movement of the user;
determining the point of gaze of the user based on the eye movement.

17. The non-transitory computer-readable medium of claim 15, further including:
receiving the touch inputs of the user from a device including pulse sensors and inertial sensors.

18. The non-transitory computer-readable medium of claim 15, wherein
the avionics system is a flight management system (FMS),
the input device is a control panel of a flight control unit (FCU) or a multi-function control and display unit (MCDU),
the functionality is a flight planning functionality of the FMS, and
the output data includes flight plan information generated by simulation of the flight planning functionality.

19. The non-transitory computer-readable medium of claim 15, wherein
the control panel apparatus includes a user-manipulable object, the user-manipulable object being a button, switch, or knob representing a button, switch, or knob of the input device, and
the physical interaction is a manipulation of the user-manipulable object by the user.

20. The non-transitory computer-readable medium of claim 15, wherein the virtual or augmented reality simulation of the user interface of the avionics system includes an augmented reality display of the user interface of the avionics system overlaid on the control panel apparatus.
